(19) United States
(12) Patent Application Publication
(10) Pub. No.: US 2025/0170949 A1
(43) Pub. Date: May 29, 2025

(54) SYSTEM AND METHOD FOR ILLUMINATING OBJECTS

(71) Applicant: GM GLOBAL TECHNOLOGY OPERATIONS LLC, Detroit, MI (US)

(72) Inventor: Matthew J. Van Vleet, Ferndale, MI (US)

(73) Assignee: GM GLOBAL TECHNOLOGY OPERATIONS LLC, Detroit, MI (US)

(21) Appl. No.: 18/520,790

(22) Filed: Nov. 28, 2023

(51) Int. Cl. B60Q 1/24; B60Q 1/08

(52) U.S. Cl. CPC B60Q 1/245; B60Q 1/085; B60Q 2300/314; B60Q 2300/45; B60Q 2400/50

(57) ABSTRACT

A method of operating a vehicle. The method includes identifying a dynamic object with at least one sensor on the vehicle and determining if an area surrounding the vehicle includes low ambient light conditions. An object class for the dynamic object is then determined. A detection status of the dynamic object is determined with an optical sensor during the low ambient light conditions. The dynamic object is illuminated with an illumination source from the vehicle based on the detection status or the object class during the low ambient lighting conditions.

### INTRODUCTION

The present disclosure relates to a system and a method for illuminating dynamic objects with an adaptive head lamp system on a vehicle.

Adaptive head lamp systems can include a headlight housing attached to the vehicle for mounting lamp units. The lamp units are either moveable or utilize an array of lights that can be turned on/off to change a projection direction relative to the vehicle such that the projection direction may not align with the heading of the vehicle. In particular, the projection direction of the lamp units may change when the vehicle is maneuvering or turning to improve visibility in the direction of travel.

### SUMMARY

This disclosure is directed to a method of operating a vehicle. The method includes identifying a dynamic object with at least one sensor on the vehicle and determining if an area surrounding the vehicle includes low ambient light conditions. An object class for the dynamic object is then determined. A detection status of the dynamic object is determined with an optical sensor during the low ambient light conditions. The dynamic object is illuminated with an illumination source from the vehicle based on the detection status or the object class during the low ambient lighting conditions.

Another aspect of the disclosure may be where illuminating the dynamic object with the illumination source occurs if the detection status of the dynamic object by the optical sensor includes not detected.

Another aspect of the disclosure may include determining a direction of travel of the dynamic object relative to the vehicle when the detection status of the dynamic object by the optical sensor includes detected.

Another aspect of the disclosure may include identifying an illumination status of at least one of head lamps or turn lamps on the dynamic object when the direction of travel of the dynamic object is opposing a direction of travel of the vehicle and illuminating the dynamic object if the illumination status is off or unknown.

Another aspect of the disclosure may include identifying an illumination status of at least one of brake lamps or turn lamps on the dynamic object when the direction of travel of the dynamic object is common with a direction of travel of the vehicle and illuminating the dynamic object if the illumination status is off or unknown.

Another aspect of the disclosure may be where determining if an area surrounding the vehicle includes the low ambient light conditions by measuring an ambient light condition in the area surrounding the vehicle with a light sensor on the vehicle.

Another aspect of the disclosure may include determining a vertical height of the dynamic object relative to a road surface with the at least one sensor and wherein illuminating the dynamic object with the illumination source includes illuminating the dynamic object for a predetermined vertical distance from a road surface.

Another aspect of the disclosure may be where illuminating the dynamic object includes projecting a pattern of light onto a road surface between the illumination source and the dynamic object.

Another aspect of the disclosure may be where illuminating the dynamic object includes projecting a pattern of light onto a road surface between the illumination source and the dynamic object and onto the dynamic object.

Another aspect of the disclosure may be where illuminating the dynamic object with the illumination source includes tracking movement of the dynamic object relative to the vehicle with the illumination source.

Another aspect of the disclosure may be where illuminating the dynamic object with the illumination source occurs if the object class determined is a bicycle.

Another aspect of the disclosure may be where the illumination source includes an adaptive head lamp system on the vehicle.

Another aspect of the disclosure may be where the adaptive head lamp system includes at least one projector type head lamp.

Disclosed herein is a non-transitory computer-readable storage medium embodying programmed instructions which, when executed by a processor, are operable for performing a method. The method includes identifying a dynamic object with at least one sensor on the vehicle and determining if an area surrounding the vehicle includes low ambient light conditions. An object class for the dynamic object is then determined. A detection status of the dynamic object is determined with an optical sensor during the low ambient light conditions. The dynamic object is illuminated with an illumination source from the vehicle based on the detection status or the object class during the low ambient lighting conditions.

Disclosed here in a vehicle. The vehicle includes a body defining a passenger compartment, wheels supporting the body, sensors fixed relative to the body, and an adaptive head lamp system fixed relative to the body. The vehicle also includes a controller in communication with the sensors and the adaptive head lamp system. The controller being configured to identify a dynamic object with at least one sensor on the vehicle and determine if an area surrounding the vehicle includes low ambient light conditions. The controller is also configured to determine an object class for the dynamic object and determine a detection status of the dynamic object with an optical sensor during the low ambient light conditions. Furthermore, the controller is configured to illuminate the dynamic object with an illumination source from the vehicle based on the detection status or the object class during the low ambient lighting conditions.

### BRIEF DESCRIPTION OF THE DRAWINGS

FIG. 1 is a schematic illustration of an example vehicle.

FIG. 2 illustrates a method of operating the vehicle of FIG. 1 by illuminating a dynamic object in low ambient light conditions.

FIG. 3 schematically illustrates the vehicle of FIG. 1 illuminating the dynamic object.

The present disclosure may be modified or embodied in alternative forms, with representative embodiments shown in the drawings and described in detail below. The present disclosure is not limited to the disclosed embodiments. Rather, the present disclosure is intended to cover alternatives falling within the scope of the disclosure as defined by the appended claims.

### DETAILED DESCRIPTION

Those having ordinary skill in the art will recognize that terms such as “above,” “below”, “upward”, “downward”, “top”, “bottom”, “left”, “right”, etc., are used descriptively for the figures, and do not represent limitations on the scope of the disclosure, as defined by the appended claims. Furthermore, the teachings may be described herein in terms of functional and/or logical block components and/or various processing steps. It should be realized that such block components may include a number of hardware, software, and/or firmware components configured to perform the specified functions.

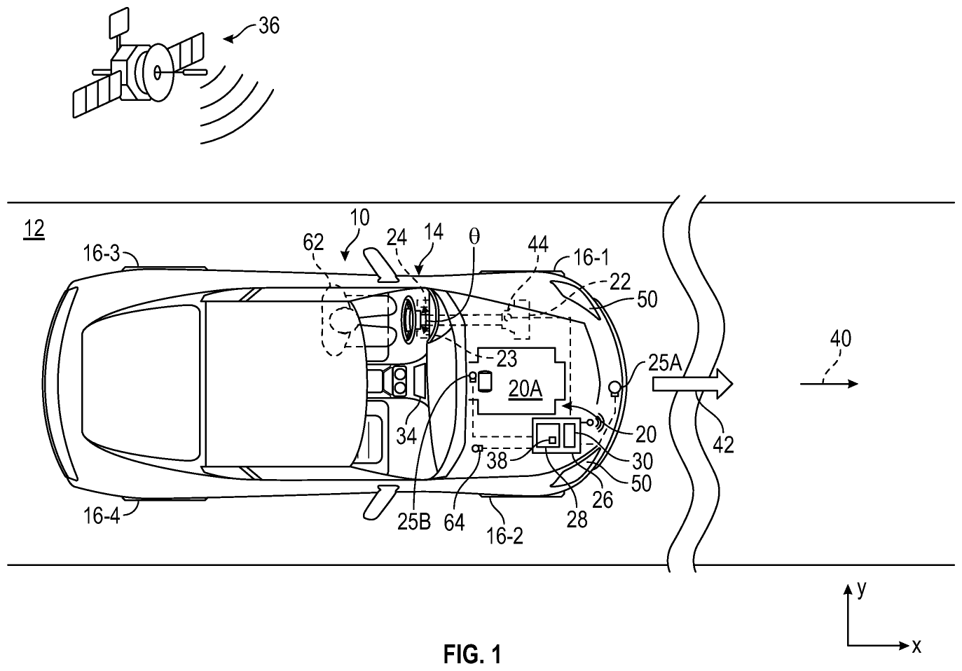

Referring to the FIGS., wherein like numerals indicate like parts referring to the drawings, wherein like reference numbers refer to like components, FIG. 1 shows a schematic view of a motor vehicle 10 positioned relative to a road surface 12, such as a vehicle lane. As shown in FIG. 1, the vehicle 10 includes a vehicle body 14, a first axle having a first set of road wheels 16-1, 16-2, and a second axle having a second set of road wheels 16-3, 16-4 (such as individual left-side and right-side wheels on each axle). Each of the road wheels 16-1, 16-2, 16-3, 16-4 employs tires configured to provide frictional contact with the road surface 12. Although two axles, with the respective road wheels 16-1, 16-2, 16-3, 16-4, are specifically shown, nothing precludes the motor vehicle 10 from having additional axles.

As shown in FIG. 1, a vehicle suspension system operatively connects the vehicle body 14 to the respective sets of road wheels 16-1, 16-2, 16-3, 16-4 for maintaining contact between the wheels and the road surface 12, and for maintaining handling of the motor vehicle 10. The motor vehicle 10 additionally includes a drivetrain 20 having a power-source or multiple power-sources 20A, which may be an internal combustion engine (ICE), an electric motor, or a combination of such devices, configured to transmit a drive torque to the road wheels 16-1, 16-2 and/or the road wheels 16-3, 16-4. The motor vehicle 10 also employs vehicle operating or control systems, including devices such as one or more steering actuators 22 (for example, an electrical power steering unit) configured to steer the road wheels 16-1, 16-2, a steering angle (θ), an accelerator device 23 for controlling power output of the power-source(s) 20A, a braking switch or device 24 for retarding rotation of the road wheels 16-1 and 16-2 (such as via individual friction brakes located at respective road wheels), etc.

As shown in FIG. 1, the motor vehicle 10 includes at least one sensor 25A and an electronic controller 26 that cooperate to at least partially control, guide, and maneuver the vehicle 10 in an autonomous mode during certain situations. As such, the vehicle 10 may be referred to as an autonomous vehicle. To enable efficient and reliable autonomous vehicle control, the electronic controller 26 may be in operative communication with the steering actuator(s) 22 configured as an electrical power steering unit, accelerator device 23, and braking device 24. The sensors 25A of the motor vehicle 10 are operable to sense the road surface 12 and monitor a surrounding geographical area and traffic conditions proximate to the motor vehicle 10.

The sensors 25A of the vehicle 10 may include, but are not limited to, at least one of a Light Detection and Ranging (LIDAR) sensor, radar, or camera (optical sensor) located around the vehicle 10 to detect the boundary indicators, such as edge conditions, of the road surface 12. The vehicle 10 may also include an ambient light sensor 64 for measuring light levels in an area surrounding the vehicle 10. The type of sensors 25A, their location on the vehicle 10, and their operation for detecting and/or sensing the boundary indicators of the road surface 12 and monitor the surrounding geographical area and traffic conditions are understood by those skilled in the art, are not pertinent to the teachings of this disclosure, and are therefore not described in detail herein. The vehicle 10 may additionally include sensors 25B attached to the vehicle body and/or drivetrain 20. Furthermore, the vehicle 10 may include dynamic or adaptive head lamp system 50 that can change a direction that the head lamps project relative to a heading on the vehicle 10 or the adaptive head lamp system 50 can include an array of lights that are selectively operatable to highly certain areas.

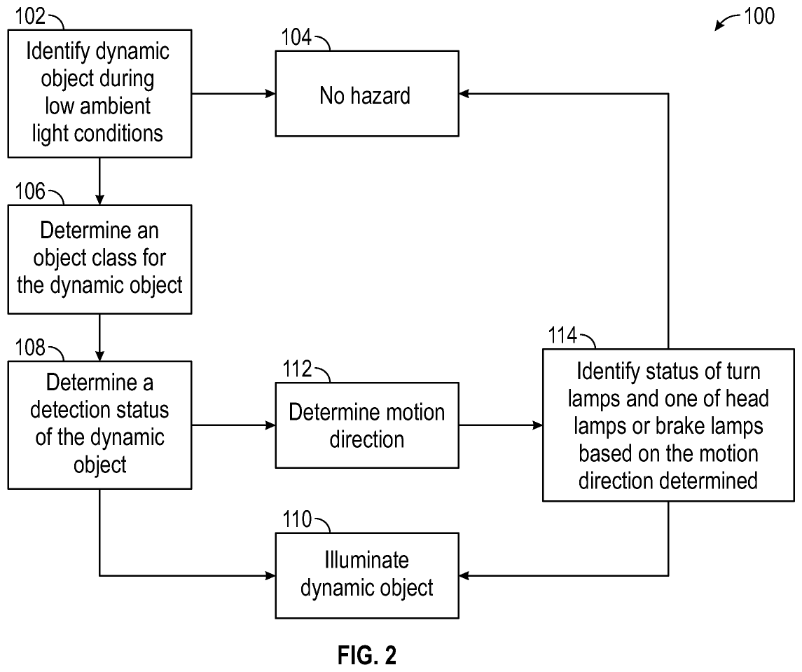

The electronic controller 26 is disposed in communication with the sensors 25A of the vehicle 10 for receiving their respective sensed data related to the detection or sensing of the road surface 12 and monitoring of the surrounding geographical area and traffic conditions. The electronic controller 26 may alternatively be referred to as a control module, a control unit, a controller, a vehicle 10 controller, a computer, etc. The electronic controller 26 may include a computer and/or processor 28, and include software, hardware, memory, algorithms, connections (such as to sensors 25A and 25B), etc., for managing and controlling the operation of the vehicle 10. As such, a method, described below and generally represented in FIG. 2, may be embodied as a program or algorithm partially operable on the electronic controller 26. It should be appreciated that the electronic controller 26 may include a device capable of analyzing data from the sensors 25A and 25B, comparing data, making the decisions required to control the operation of the vehicle 10, and executing the required tasks to control the operation of the vehicle 10.

The electronic controller 26 may be embodied as one or multiple digital computers or host machines each having one or more processors 28, read only memory (ROM), random access memory (RAM), electrically-programmable read only memory (EPROM), optical drives, magnetic drives, etc., a high-speed clock, analog-to-digital (A/D) circuitry, digital-to-analog (D/A) circuitry, and input/output (I/O) circuitry, I/O devices, and communication interfaces, as well as signal conditioning and buffer electronics. The computer-readable memory may include non-transitory/tangible medium which participates in providing data or computer-readable instructions. Memory may be non-volatile or volatile. Non-volatile media may include, for example, optical or magnetic disks and other persistent memory. Example volatile media may include dynamic random-access memory (DRAM), which may constitute a main memory. Other examples of embodiments for memory include a flexible disk, hard disk, magnetic tape or other magnetic medium, a CD-ROM, DVD, and/or other optical medium, as well as other possible memory devices such as flash memory.

The electronic controller 26 includes a tangible, non-transitory memory 30 on which computer-executable instructions, including one or more algorithms, are recorded for regulating operation of the motor vehicle 10. The subject algorithm(s) may specifically include an algorithm configured to control movement of the adaptive head lamp system 50.

The motor vehicle 10 also includes a vehicle navigation system 34, which may be part of integrated vehicle controls, or an add-on apparatus used to find travel direction in the vehicle. The vehicle navigation system 34 is also operatively connected to a global positioning system (GPS) 36 using an earth orbiting satellite. The vehicle navigation system 34 in connection with the GPS 36 and the above-mentioned sensors 25A may be used for automation of the vehicle 10. The electronic controller 26 is in communication with the GPS 36 via the vehicle navigation system 34. The vehicle navigation system 34 uses a satellite navigation device (not shown) to receive its position data from the GPS 36, which is then correlated to the vehicle's position relative to the surrounding geographical area. Based on such information, when directions to a specific waypoint are needed, routing to such a destination may be mapped and calculated. On-the-fly terrain and/or traffic information may be used to adjust the route. The current position of a vehicle 10 may be calculated via dead reckoning—by using a previously determined position and advancing that position based upon given or estimated speeds over elapsed time and course by way of discrete control points.

The electronic controller 26 is generally configured, i.e., programmed, to determine or identify localization 38 (current position in the X-Y plane, shown in FIG. 1), velocity, acceleration, yaw rate, as well as intended path 40, and heading 42 of the motor vehicle 10 on the road surface 12. The localization 38, intended path 40, and heading 42 of the motor vehicle 10 may be determined via the navigation system 34 receiving data from the GPS 36, while velocity, acceleration (including longitudinal and lateral g's), and yaw rate may be determined from vehicle sensors 25B. Alternatively, the electronic controller 26 may use other systems or detection sources arranged remotely with respect to the vehicle 10, for example a camera, to determine localization 38 of the vehicle relative to the road surface 12.

As noted above, the motor vehicle 10 may be configured to operate in an autonomous mode guided by the electronic controller 26 to transport an occupant or driver 62. In such a mode, the electronic controller 26 may further obtain data from vehicle sensors 25B to guide the vehicle along the desired path, such as via regulating the steering actuator 22. The electronic controller 26 may be additionally programmed to detect and monitor the steering angle (θ) of the steering actuator(s) 22 along the desired path 40, such as during a negotiated turn. Specifically, the electronic controller 26 may be programmed to determine the steering angle (θ) via receiving and processing data signals from a steering position sensor 44 (shown in FIG. 1) in communication with the steering actuator(s) 22, accelerator device 23, and braking device 24.

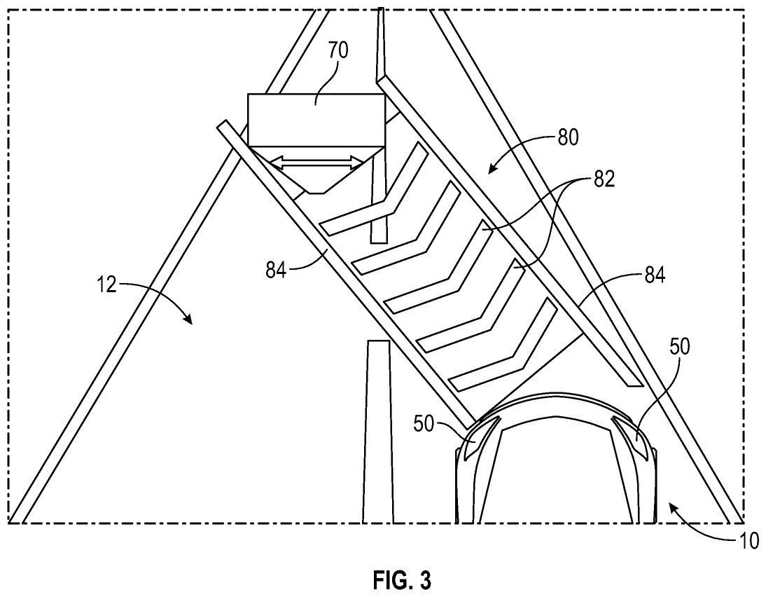

FIG. 2 illustrates a method 100 of detecting and identifying objects, such as dynamic or moving objects, during low ambient light conditions. At Block 102, the method 100 begins by identifying at least one dynamic object and determining if an area surrounding the vehicle 10 includes low ambient light conditions. The method 100 utilizes the at least one of the sensors 25A, 25B, such as radar, lidar, or optical sensors, to detect an object 70, such as the dynamic object 70 shown in FIG. 3. In one example, the method 100 can determine if the object 70 is a dynamic object if the object 70 includes a minimum velocity relative to a ground truth.

Furthermore, at Block 102, the method 100 determines if the area surrounding the vehicle 10 includes low ambient light conditions with the ambient light sensor 64 located on the vehicle 10. The ambient light conditions can be determined as low if the level of light measured by the light sensor 64 is below a predetermined threshold. Alternatively, the ambient light conditions can be determined to be low based on a time of day.

During operation of the vehicle 10, the low ambient light conditions can influence the visibility of the object 70, especially if the object 70 does not include its own source of illumination. However, if the object 70 isn't dynamic, such as a parked car, or if the area surrounding the vehicle 10 does not include the low ambient light conditions, the method 100 proceeds to Block 104. At Block 104 the method 100 determines that the object 70 does not pose a hazard to the vehicle 10 and does not treat the object any differently than the surrounding environment.

If the object 70 is determined to be a dynamic object and the ambient light conditions are determined to be low, the method 100 proceeds to Block 106 to determine an object class for the object 70. The object class for the dynamic object can include person, bicycle, vehicle, etc. By determining the object class at Block 106, the method 100 can determine if certain classes of objects, such as bicycles, should be automatically illuminated in low ambient light conditions independent of the object's own source of illumination.

At Block 108, the method 100 determines which of the sensors 25A and 25B can identify the object 70. In particular, the method 100 determines a detection status of the object 70 based on one of the optical sensors being able to identify the dynamic object 70 as opposed to one or more of the radar or lidar sensors being able to identify the object 70. In one example, the detection status can include “not detected” for objects 70 that were identified by one of the other sensors 25A, 25B on the vehicle 10 and not one of the optical sensors during the low ambient light conditions. Alternatively, the detection status can include “detected” for dynamic objects 70 that were identified by one of the other sensors 25A, 25B in addition to one of the optical sensors during the low ambient light conditions.

If the detection status for the object 70 is “not detected” or if the object 70 is classified in a group that is automatically illuminated, such as bicycles, the method 100 proceeds to Block 110 and illuminates the object 70. The method 100 can utilize the adaptive head lamp system 50 on the vehicle 10 to provide the illumination for the object 70. In one example, the adaptive head lamp system 50 includes a projector type head lamp with a physical shutter for controlling illumination from a light source. Alternative, or in addition to the shutter, the adaptive head lamp system 50 can include a light emitting diode (LED) projector type head lamp system that can selectively control the illumination of the individual LEDs for illuminating portions of the object 70. This can allow the adaptive head lamp system 50 to create the pattern of light 80 as discussed below. Also, one or both of the head lamps in the adaptive head lamp system 50 can be used for illuminating the object 70 based on the relative position of the object 70 in relation to the vehicle 10.

The adaptive head lamp system 50 can illuminate the object 70 in several different ways. For example, the sensors 25A and 25B can determine a vertical height of the object 70 relative to the road surface 12. The adaptive head lamp system 50 can then be directed to illuminate the object 70 for a predetermined vertical distance from the road surface 12. One feature of this approach is to reduce the possibility of glaring an operator of the object 70. The predetermined distance from the road surface 12 can also vary depending on the object class determined for the object 70. For example, the predetermined distance may be greater if the object class was determined to be a commercial vehicle as opposed to a passenger or compact car.

Furthermore, the adaptive head lamp system 50 can be used to project a pattern of light 80 the roadway in the direction of the object 70. In the illustrated example of FIG. 3, the pattern of light 80 can include at least one of ground highlighting 84 or directional markers 82. In the illustrated example, the ground highlighting 84 includes lines extending from the vehicle 10 that are at least as wide as the object 70 wherein the ground highlighting intersects the object 70. The directional markers 82 can include varying shapes such as arrows or chevrons. One feature of the ground highlighting and the directional markers 82 is to aid the operator of the vehicle 10 to quickly identify the object 70 in the low ambient light conditions as shown in FIG. 3.

Additionally, when illuminating the object 70 with the adaptive head lamp system 50, the illumination, such as the pattern of light 80, can track the movement of the object 70 relative to the vehicle 10 within a predetermined angular range of a heading of the vehicle 10. In one example, the predetermined angular range includes an angular range of between zero degrees (i.e., along the heading of the vehicle 10) to approximately 90 degrees. In another example, the predetermined angular range can include between zero and 75 degrees. The adaptive head lamp system 50 can also track the object 70 as long as it remains within a predetermined distance from the vehicle 10.

At Block 108, when the detection status is “detected” by one of the optical sensors and the object class is not one that is automatically illuminated by the adaptive head lamp system 50, the method 100 proceeds to Block 112. When the method the proceeds to Block 112, the object 70 can include vehicles or other dynamic objects that are either self-illuminated, such as by head or brake lamps, as well as dynamic objects that are not self-illuminated.

At Block 112, the method 100 determines a direction of motion for the object 70. The direction of motion for the object 70 can include a common or similar direction of travel as the vehicle 10. Alternatively, the direction of motion for the object 70 can include an opposing or opposite direction of travel relative to the vehicle 10.

Once the direction of travel of the object 70 has been determined relative to the vehicle 10, the method proceeds to Block 114. At Block 114, the method 100 determines an illumination status of the object 70 by attempting to identify lamps on the object 70, such as head lamps, brake lamps, or turn lamps. If the lamps cannot be identified, the illumination status is off or unknown. If the lamps on the object 70 can be identified, then the illumination status is “on” or “illuminated”.

In the case of the object 70 traveling in a common direction with the vehicle 10, the method 100 attempts to identify one of the brake lamps or one of the turn lamps on the object 70 with the optical sensor on the vehicle 10. If the optical sensor cannot identify one of the brake lamps or one of the turn lamps, the illumination status becomes “off” or “unknown”. If the illumination status is off or unknown, the method 100 proceeds to Block 110 and illuminates the object 70 as discussed above. However, if the illumination status is “on” or “illuminated”, the method 100 proceeds to Block 104 and does not illuminate the object 70.

In the case of the object 70 traveling in the opposing direction relative to the vehicle 10, the method 100 attempts to identify one of the head lamps or one of the turn lamps on the object 70 with the optical sensor on the vehicle 10. If the optical sensor cannot identify one of the head lamps or one of the turn lamps, the illumination status becomes “off” or “unknown”. If the illumination status is “off” or “unknown”, the method 100 proceeds to Block 110 and illuminates the object 70 as discussed above. However, if the illumination status is “on” or “illuminated”, the method 100 proceeds to Block 104 and does not illuminate the object 70.

For purposes of this Detailed Description, unless specifically disclaimed: the singular includes the plural and vice versa; the words “and” and “or” shall be both conjunctive and disjunctive; the words “any” and “all” shall both mean “any and all”; and the words “including,” “containing,” “comprising,” “having,” and the like, shall each mean “including without limitation.” Moreover, words of approximation, such as “about,” “almost,” “substantially,” “generally,” “approximately,” and the like, may each be used herein to denote “at, near, or nearly at,” or “within 0-5% of,” or “within acceptable manufacturing tolerances,” or any logical combination thereof, for example. Lastly, directional adjectives and adverbs, such as fore, aft, inboard, outboard, starboard, port, vertical, horizontal, upward, downward, front, back, left, right, etc., may be with respect to a motor vehicle, such as a forward driving direction of a motor vehicle when the vehicle is operatively oriented on a horizontal driving surface.

While the best modes for carrying out the disclosure have been described in detail, those familiar with the art to which this disclosure relates will recognize various alternative designs and embodiments for practicing the disclosure within the scope of the appended claims.

Any of the dimensions, configurations, etc. discussed herein may be varied as needed or desired to be different than any value or characteristic specifically mentioned herein or shown in the drawings for any of the embodiments.

It will be apparent to those skilled in the art that various modifications and variations can be made to the embodiments of the apparatus and methods of assembly as discussed herein without departing from the scope or spirit of the disclosure(s). Other embodiments of this disclosure will be apparent to those skilled in the art from consideration of the specification and practice of the various embodiments disclosed herein. For example, some of the equipment may be constructed and function differently than what has been described herein and certain steps of any method may be omitted, performed in an order that is different than what has been specifically mentioned or in some cases performed simultaneously or in sub-steps. Furthermore, variations or modifications to certain aspects or features of various embodiments may be made to create further embodiments and features and aspects of various embodiments may be added to or substituted for other features or aspects of other embodiments to provide still further embodiments.

What is claimed is:

1. A method of operating a vehicle, the method comprising:
identifying a dynamic object with at least one sensor on the vehicle;
determining if an area surrounding the vehicle includes low ambient light conditions;
determining an object class for the dynamic object;
determining a detection status of the dynamic object with an optical sensor during the low ambient light conditions; and
illuminating the dynamic object with an illumination source from the vehicle based on the detection status or the object class during the low ambient lighting conditions.

2. The method of claim 1, wherein illuminating the dynamic object with the illumination source occurs if the detection status of the dynamic object by the optical sensor includes not detected.

3. The method of claim 1, including determining a direction of travel of the dynamic object relative to the vehicle when the detection status of the dynamic object by the optical sensor includes detected.

4. The method of claim 3, including identifying an illumination status of at least one of head lamps or turn lamps on the dynamic object when the direction of travel of the dynamic object is opposing a direction of travel of the vehicle and illuminating the dynamic object if the illumination status is off or unknown.

5. The method of claim 3, including identifying an illumination status of at least one of brake lamps or turn lamps on the dynamic object when the direction of travel of the dynamic object is common with a direction of travel of the vehicle and illuminating the dynamic object if the illumination status is off or unknown.

6. The method of claim 1, wherein determining if an area surrounding the vehicle includes the low ambient light conditions by measuring an ambient light condition in the area surrounding the vehicle with a light sensor on the vehicle.

7. The method of claim 1, including determining a vertical height of the dynamic object relative to a road surface with the at least one sensor and wherein illuminating the dynamic object with the illumination source includes illuminating the dynamic object for a predetermined vertical distance from a road surface.

8. The method of claim 1, wherein illuminating the dynamic object includes projecting a pattern of light onto a road surface between the illumination source and the dynamic object.

9. The method of claim 1, wherein illuminating the dynamic object includes projecting a pattern of light onto a road surface between the illumination source and the dynamic object and onto the dynamic object.

10. The method of claim 1, wherein illuminating the dynamic object with the illumination source includes tracking movement of the dynamic object relative to the vehicle with the illumination source.

11. The method of claim 1, wherein illuminating the dynamic object with the illumination source occurs if the object class determined is a bicycle.

12. The method of claim 1, wherein the illumination source includes an adaptive head lamp system on the vehicle.

13. The method of claim 12, wherein the adaptive head lamp system includes at least one projector type head lamp.

14. A non-transitory computer-readable storage medium embodying programmed instructions which, when executed by a processor, are operable for performing a method comprising:
identifying a dynamic object with at least one sensor on a vehicle;
determining if an area surrounding the vehicle includes low ambient light conditions;
determining an object class for the dynamic object;
determining a detection status of the dynamic object with an optical sensor during the low ambient light conditions; and
illuminating the dynamic object with an illumination source from the vehicle based on the detection status or the object class during the low ambient lighting conditions.

15. The storage medium of claim 14, wherein illuminating the dynamic object with the illumination source occurs if the detection status of the dynamic object by the optical sensor includes not detected.

16. The storage medium of claim 14, including determining a direction of travel of the dynamic object relative to the vehicle when the detection status of the dynamic object by the optical sensor includes detected.

17. The storage medium of claim 16, including identifying an illumination status of at least one of head lamps or turn lamps on the dynamic object when the direction of travel of the dynamic object is opposing a direction of travel of the vehicle and illuminating the dynamic object if the illumination status is off or unknown.

18. The storage medium of claim 16, including identifying an illumination status of at least one of brake lamps or turn lamps on the dynamic object when the direction of travel of the dynamic object is common with a direction of travel of the vehicle and illuminating the dynamic object if the illumination status is off or unknown.

19. A vehicle comprising:
a body defining a passenger compartment;
a plurality of wheels supporting the body;
a plurality of sensors fixed relative to the body;
an adaptive head lamp system fixed relative to the body; and
a controller in communication with the plurality of sensors and the adaptive head lamp system, the controller being configured to:
identify a dynamic object with at least one sensor on the vehicle;
determine if an area surrounding the vehicle includes low ambient light conditions;
determine an object class for the dynamic object;
determine a detection status of the dynamic object with an optical sensor during the low ambient light conditions; and
illuminate the dynamic object with an illumination source from the vehicle based on the detection status or the object class during the low ambient lighting conditions.

20. The vehicle of claim 19, wherein the controller is configured to illuminate the dynamic object with the illumination source if the detection status of the dynamic object by the optical sensor includes not detected.
